(19) United States
(12) Patent Application Publication
(10) Pub. No.: US 2026/0203872 A1
(43) Pub. Date: Jul. 16, 2026

(54) VIEW SYNTHESIS METHOD WITH CONDITIONAL IMAGE GENERATION

(71) Applicant: HITACHI, Ltd., Tokyo (JP)

(72) Inventors: Masato TAMURA, San Jose, CA (US); Ravigopal VENNELAKANTI, San Jose, CA (US); Malarvizhi SANKARANARAYANASAMY, Mountain View, CA (US)

(21) Appl. No.: 19/025,699

(22) Filed: Jan. 16, 2025

(51) Int. Cl. G06T 5/70; G06T 5/50; G06T 5/60; G06T 7/73; G06T 15/06; G06T 15/20

(52) U.S. Cl. CPC G06T 5/70; G06T 5/50; G06T 5/60; G06T 7/74; G06T 15/06; G06T 15/20; G06T 2207/10028; G06T 2207/20081; G06T 2207/20084; G06T 2207/30244

(57) ABSTRACT

Systems and methods described herein improve view synthesis by using an image generation network to reduce noise in synthesized images from camera poses not included in training data. View synthesis networks are trained with two sets of data: one for learning 3D structure and another for training the image generation network to remove artifacts. An image generation network can then clean synthesized views with random camera poses, enhancing the training data for view synthesis networks and ensuring noise-free outputs. The network can be shared across multiple view synthesis tasks, improving noise reduction by leveraging more training samples.

### BACKGROUND

### Field

The present disclosure is generally directed to computer vision, and more specifically, to systems and methods for view synthesis using conditional image generation.

### Related Art

View synthesis, also known as novel view synthesis, plays a vital role in various applications, such as virtual tours, virtual site inspections, and construction planning. This method is used to create views that are not captured by the camera by leveraging multiple views of target sites or objects along with corresponding camera poses. During training, view synthesis models learn the 3D structure of the target sites or objects based on the provided data. This enables the models to synthesize views from any location and angle based on the learned 3D structure during inference. Precise view synthesis allows user to quickly understand the current state of sites, facilitating planning and actions based on the synthesized views.

Recently, there have been proposals for view synthesis based on gradient optimization. One of the most successful approaches in this field is Neural Radiance Field (NeRF). It uses neural networks to synthesize views accurately by learning from images and their corresponding camera poses. NeRF represents a continuous 3D scene as a function that takes a 3D spatial coordinate and a viewing direction as input and outputs the radiance (color and opacity) at that point. The advantages of NeRF include the ability to produce high-fidelity renderings with realistic lighting effects, detailed geometry, and view-dependent effects like reflections and refractions. However, the method suffers from challenges such as high computational cost during both training and rendering, as well as the need for substantial amounts of training data. To mitigate the computational cost issue, some approaches use Gaussian splatting, which represents scenes with 3D Gaussians that preserve desirable properties of continuous volumetric radiance fields for scene optimization, while avoiding unnecessary computation in empty space. This method is analogous to triangle rasterization in computer graphics, but uses gaussians instead of triangles to represent the scene. Recent advances in graphic processing devices that facilitate relatively fast rasterization, real-time view synthesis is enabled.

While NeRF and Gaussian splatting have shown significant improvements in the quality of synthesized views, some noise often remains in the resulting views. This makes gradient optimization-based view synthesis an ongoing area of research. Embodiments herein address these shortcomings and reduce noise in views synthesized by NeRF, Gaussian splatting, or other view synthesis methods that use gradient optimization.

Systems and methods herein enhance the quality of images produced by NeRF by utilizing generative adversarial networks (GANs).

### SUMMARY

In some aspects of the disclosure, a method for reducing noise in synthesized images generated by a view synthesis network using an image generation network comprises: capturing images of one or more target objects or sites using cameras; estimating camera poses for the captured images; for each target object or site, dividing training samples including image-camera pose pairs into a first training set and a second training set; providing camera poses associated with the first training set to a view synthesis network, which synthesizes views from the camera poses to obtain a first set of synthesized images; comparing the first set of synthesized images with images in the first training set to obtain a first comparison result; inputting the first comparison result to the view synthesis network; providing camera poses associated with the second training set to the view synthesis network, which synthesizes views from the camera poses to obtain a second set of synthesized images; providing the second set of synthesized images to an image generation network to generate noise-reduced images; comparing the noise-reduced images with images in the second training set to obtain a second comparison result; and inputting the second comparison result to the image generation network, wherein the view synthesis network has not been trained on images associated with the second training set.

In some aspects, the method further comprises using the noise-reduced images as additional training samples for the view synthesis network, and using at least some of the randomly sampled camera poses to train the view synthesis networks to enable the view synthesis networks to learn additional 3D structures consistently.

In some aspects, the synthesized views from randomly sampled camera poses are input into the image generation network before being used as additional training samples. Estimating the camera poses for the captured images may comprise using at least one of a structure-from-motion algorithm or a point-matching algorithm, wherein the point-matching algorithm is used in response to capturing depth data with 3D sensors to enhance a camera pose estimation.

In some aspects, the method further comprises sharing one or more image generation network parameters across two or more view synthesis networks to improve a noise reduction performance based on accumulated training data, which may use training data from two or more target objects or sites.

In some aspects, the techniques described herein relate to a method, wherein the one or more shared image generation networks use training data from multiple target objects or sites to enhance noise reduction performance across different view synthesis networks, which each may learn its own target site or object and generate views by casting rays from a camera center in the view direction and sampling points along the rays.

In some aspects, the method further comprises optimizing the image generation network by comparing synthesized images with real images from the second training set using an objective function, and calculating pixel values of the view by integrating the colors and densities of sampled points.

In some aspects, the techniques described herein relate to a non-transitory computer-readable medium for storing instructions for executing a process, the instructions comprising: in response to cameras capturing images of one or more target objects or sites, estimating camera poses for the captured images; for each target object or site, dividing training samples including image-camera pose pairs into a first training set and a second training set; providing camera poses associated with the first training set to a view synthesis network, which synthesizes views from the camera poses to obtain a first set of synthesized images; comparing the first set of synthesized images with images in the first training set to obtain a first comparison result; inputting the first comparison result to the view synthesis network; providing camera poses associated with the second training set to the view synthesis network, which synthesizes views from the camera poses to obtain a second set of synthesized images; providing the second set of synthesized images to an image generation network to generate noise-reduced images; comparing the noise-reduced images with images in the second training set to obtain a second comparison result; and inputting the second comparison result to the image generation network, wherein the view synthesis network has not been trained on images associated with the second training set.

Aspects of the present disclosure can involve a system, which can involve means for capturing images of one or more target objects or sites using cameras; estimating camera poses for the captured images; for each target object or site, means may divide training samples including image-camera pose pairs into a first training set and a second training set, and provide camera poses associated with the first training set to a view synthesis network, which synthesizes views from the camera poses to obtain a first set of synthesized images.

Aspects of the present disclosure can further involve a system, which can involve means for comparing the first set of synthesized images with images in the first training set to obtain a first comparison result; inputting the first comparison result to the view synthesis network; providing camera poses associated with the second training set to the view synthesis network, which synthesizes views from the camera poses to obtain a second set of synthesized images; providing the second set of synthesized images to an image generation network to generate noise-reduced images; comparing the noise-reduced images with images in the second training set to obtain a second comparison result; and inputting the second comparison result to the image generation network, wherein the view synthesis network has not been trained on images associated with the second training set.

### BRIEF DESCRIPTION OF DRAWINGS

FIG. 1 depicts an overview of a common generative adversarial network neural radiance field (GANeRF) method.

FIG. 2 illustrates an overview of an exemplary process according to various embodiments of the present disclosure.

FIG. 3A and FIG. 3B depict exemplary flowcharts illustrating processes for capturing data for training view synthesis networks and image generation networks, according to various embodiments of the present disclosure.

FIG. 4 depicts an overview of a view synthesis process using a feedforward network (FNN) according to various embodiments of the present disclosure.

FIG. 5 is a flowchart illustrating an exemplary view synthesis process according to the overview shown in FIG. 4.

FIG. 6 depicts an overview of an image generation process according to various embodiments of the present disclosure.

FIG. 7 is a flowchart illustrating an exemplary image generation process according to the overview shown in FIG. 6.

FIG. 8 depicts an overview of an optimization process of a view synthesis network according to various embodiments of the present disclosure.

FIG. 9 is a flowchart illustrating an exemplary process according to the overview shown in FIG. 8.

FIG. 10 depicts an overview of an optimization process for image generation network according to various embodiments of the present disclosure.

FIG. 11 is a flowchart illustrating an exemplary image generation optimization process according to the overview shown in FIG. 10.

FIG. 12 depicts an overview of an optimization process of a view synthesis network with randomly sampled camera poses according to various embodiments of the present disclosure.

FIG. 13 is a flowchart illustrating an exemplary process according to the overview shown in FIG. 12.

FIG. 14 depicts an overview of a process for sharing an image generation network according to various embodiments of the present disclosure.

FIG. 15 is a flowchart illustrating an exemplary process according to the overview shown in FIG. 14.

FIG. 16 illustrates an example computing environment with an example computer device according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

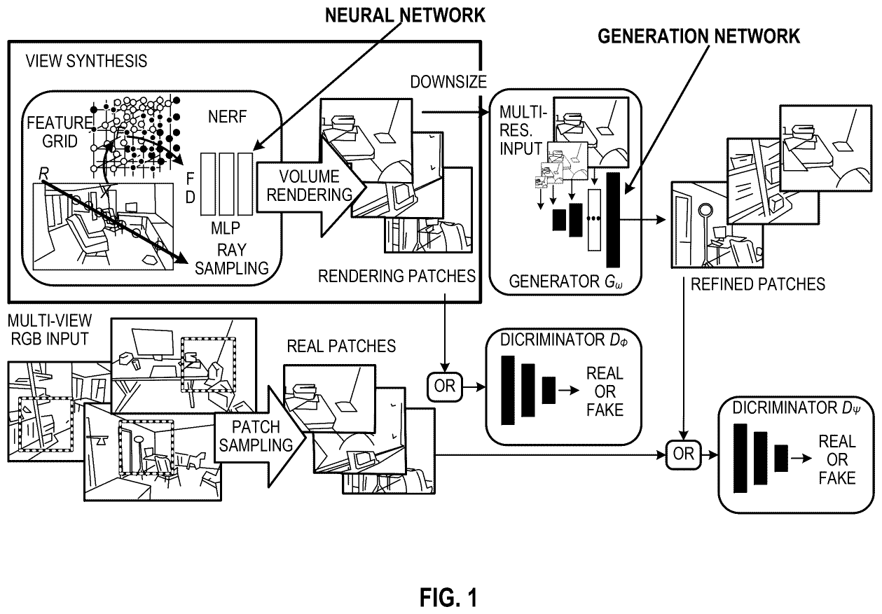

FIG. 1 depicts an overview of a common GANeRF method. The training process of the GANeRF method involves optimizing a feed-forward neural network (FNN) to generate views identical to input views based on camera poses, similar to the usual NeRF training process. In addition to the optimization process, the network is also optimized to deceive a discriminator network, DDφφ, which attempts to differentiate between real and synthesized views. Additionally, a generator network, GGωω, refines the synthesized views from the NeRF network and is optimized to deceive another discriminator network, DDψψ, which also tries to distinguish between real and synthesized views. As a result of this adversarial training, the NeRF network and the generator network produce more realistic views compared to networks trained without the discriminators, thus significantly improving the quality of the synthesized views.

However, common GANeRF methods lack explicit mechanisms to reduce noise and may struggle to reduce noise in views that are not included in the training data. View synthesis methods based on gradient optimization often create cloudy artifacts in views that are not part of the training data, whereas such artifacts are not present in views included in the training data. When camera poses not included in the training data are used to synthesize views, and these views are then used to optimize the network using the adversarial method, the artifacts may be overlooked, allowing the network to generate them.

Furthermore, the number of training samples may be limited due to the requirement of paired images and camera poses. The number of training samples is determined by the number of camera poses that can be consistently estimated, which is often limited to a few thousand due to the high computational cost of estimating camera poses. This limitation can result in the GAN not having sufficient training samples to effectively reduce noise in the synthesized images.

In contrast, in embodiments herein, as the number of training samples for the image generation network is increased, the noise reduction performance is improved. Various embodiments use an image generation network to reduce the noise of images synthesized using camera poses that are not included in the training data. Additionally, such networks can share their noise reduction capabilities with one or more view synthesis networks.

As discussed in greater detail below, to achieve this, the training data is split into two sets. One set is used to train a view synthesis network to allow them to learn the 3D structure. The other set is used to train the image generation network to reduce the noise of images that are not included in the training data. While training both networks, randomly sampled camera poses are fed into the view synthesis network, and synthesized views, which may contain cloudy artifacts, are fed into the image generation network to remove the artifacts. The randomly sampled camera poses and the generated images can be used as additional samples to further train the view synthesis network, enhancing their ability to learn consistent 3D structures. This image generation network can be shared across several view synthesis networks, each of which learns to synthesize its own target site or object. As a result of such sharing, the image generation network can learn how to remove cloudy artifacts with a large pool of training samples.

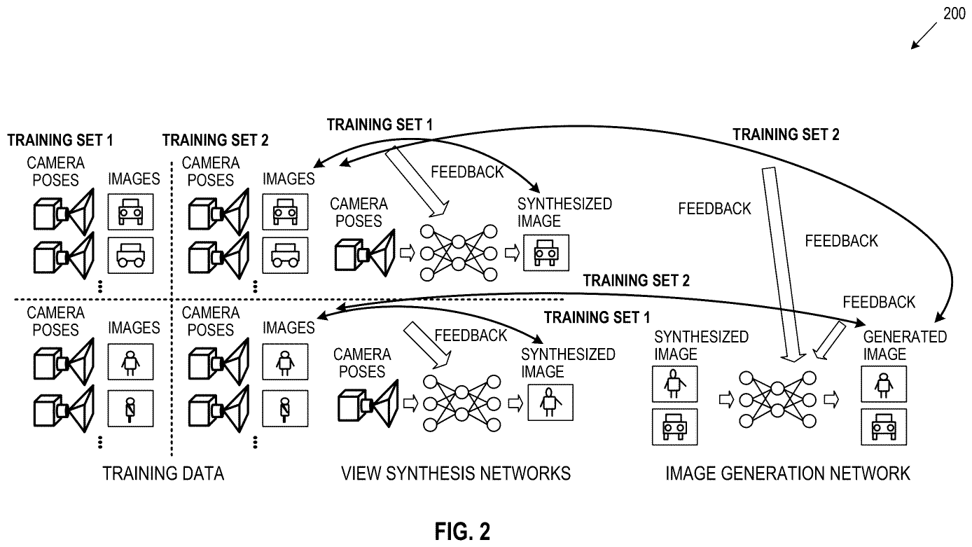

FIG. 2 illustrates an overview of an exemplary process according to various embodiments of the present disclosure. In embodiments, process 200 starts by capturing images of one or more target objects or sites using cameras. If 3D sensors are available with cameras, depth data may also be captured. After capturing the images, a structure-from-motion algorithm is used to estimate the corresponding camera poses. If depth sensors are used, an iterative closest point (ICP) algorithm may be used instead of the structure-from-motion algorithm.

For each target object or site, the obtained image-camera pose pairs are divided into two training sets. The first training set of each target object or site is used to train a view synthesis network. The camera poses of the training samples in this set are fed into the view synthesis network, and corresponding views are synthesized. The synthesized images are then compared with the images in the training set, and the comparison results are fed back to the view synthesis network, following a standard gradient-optimization-based view synthesis method.

The second set is used to train the image generation network. The camera poses of the training samples in this set are fed into the view synthesis network, and corresponding views are synthesized. The synthesized images are then fed into the image generation network to produce noise-reduced images. These generated images are compared with images in the training data, and the comparison results are fed back to the image generation network. As the view synthesis network is not trained with the samples in the second set, the synthesized images may have cloudy artifacts. The image generation network is optimized to reduce these artifacts by comparing the synthesized and training images.

While optimizing the view synthesis network and the image generation network, randomly sampled camera poses are also fed into the view synthesis network, and the synthesized images are fed into the image generation network. Although the synthesized images may contain cloudy artifacts, the image generation network can remove them due to its training with the second set of training data. The cleaned images and randomly sampled camera poses may then be used as additional training samples for the view synthesis network. This results in noise-free view synthesis networks with any camera pose.

The image generation network can be shared with multiple view synthesis networks. Although each view synthesis network learns a different target object or site, they typically generate similar artifacts. The image generation network aims to reduce those artifacts and thus can learn from training data of different target objects or sites. This network sharing increases the number of training samples for the image generation network, thereby enhancing its noise reduction performance.

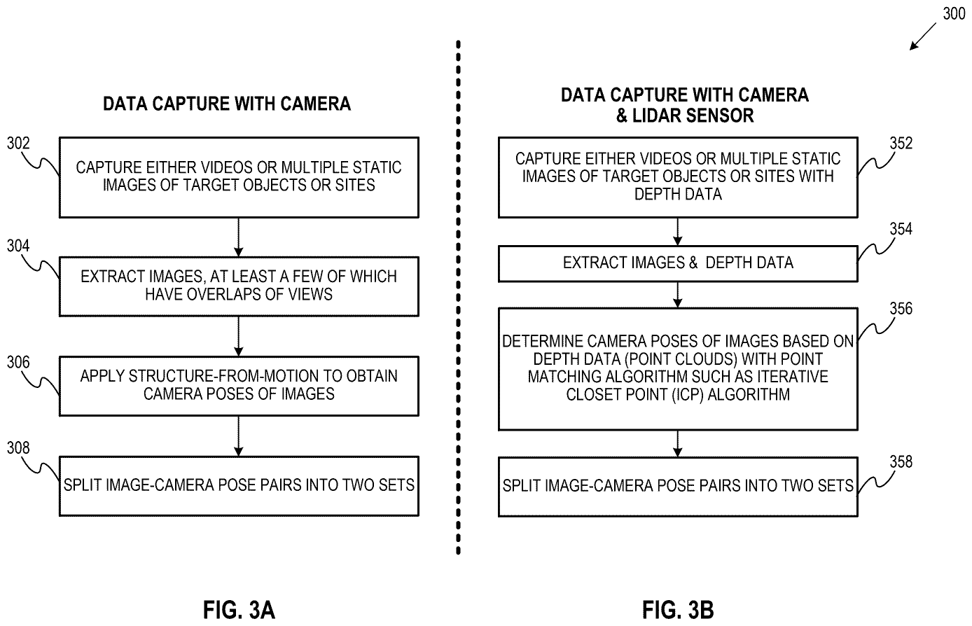

FIG. 3A and FIG. 3B depict exemplary flowcharts illustrating processes for capturing data for training view synthesis networks and image generation networks, according to various embodiments of the present disclosure. In embodiments, process 300 in FIG. 3A begins at step 302, when videos or a number of static images of target object or sites are captured by a camera. At step 304, images are extracted, at least a few of which have overlaps of views. At step 306, a structure-from-motion algorithm may be applied to images to obtain camera poses of the images. Finally, at step 308, once the image-camera pose pairs are obtained, the image-camera pose pairs are divided into two sets.

Similarly, process 350 in FIG. 3B, which 3D sensors to capture depth data, may start at step 352, when videos or a number of images of target objects or sites comprising depth data are captured by the sensors. At step 354, images and depth data are extracted before, at step 356, camera poses of images are estimated based on depth data or a point cloud data with a point-matching algorithm, such as iterative closest point (ICP). At step 358, again, once the image-camera pose pairs are obtained, they are randomly divided into two sets.

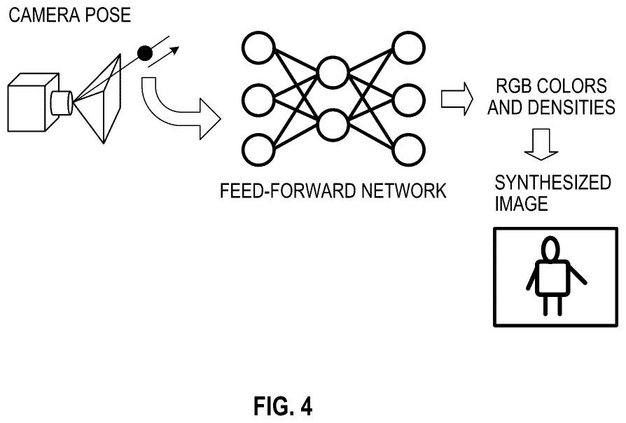

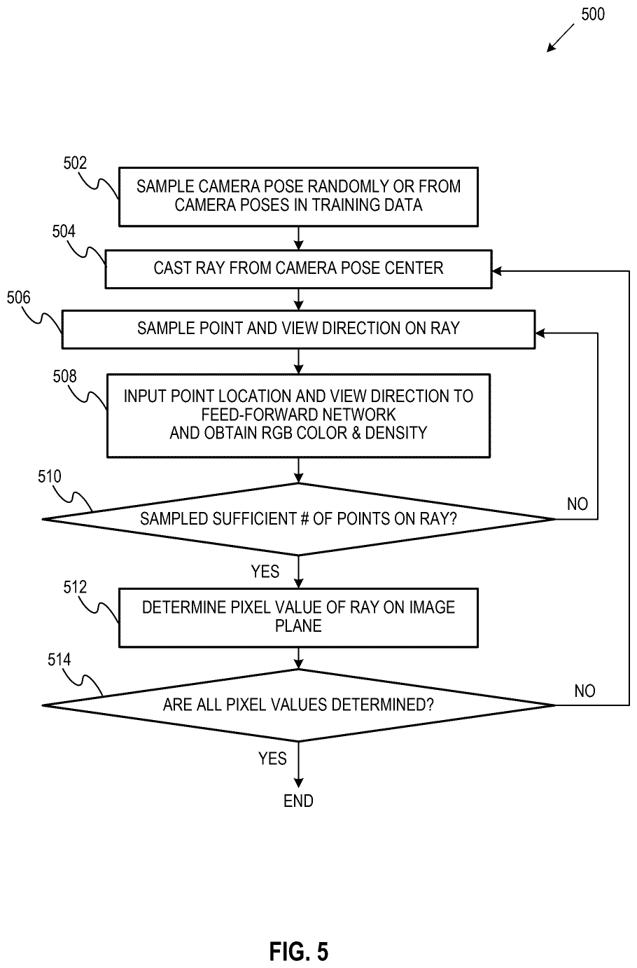

FIG. 4 depicts an overview of a view synthesis process using a feedforward network (FNN) according to various embodiments of the present disclosure. FIG. 5 is a flowchart illustrating an exemplary view synthesis process according to the overview shown in FIG. 4. In embodiments, process 500 begins at step 502, when a camera pose is sampled, e.g., selected randomly or taken from camera poses in a training data set. At step 504, a ray is cast from the camera pose center to the view direction. At step 506, a point on the ray is sampled. At step 508, the coordinates of the point and view direction of the ray are input to an FNN to obtain an RGB color and a density of the input location. This process is repeated by changing the point sampling locations until sufficient point colors and densities are obtained. At step 510, it is determined whether a sufficient number of points on the ray have been sampled. If so, the process proceeds to step 512 to calculate the pixel value of the ray on the image plane, e.g., by integrating the colors and densities. Otherwise, process 500 resumes with step 506 to continue sampling, e.g., until all the pixel values on the view are determined. Once, at step 514, all pixel values have been determined, process 500 ends and a view may be output. Otherwise, the process resumes with step 504 to continue casting rays from the camera pose center.

It is understood that while the NeRF method serves as a basis of process 500, other methods, such as Gaussian splatting, may equally be used.

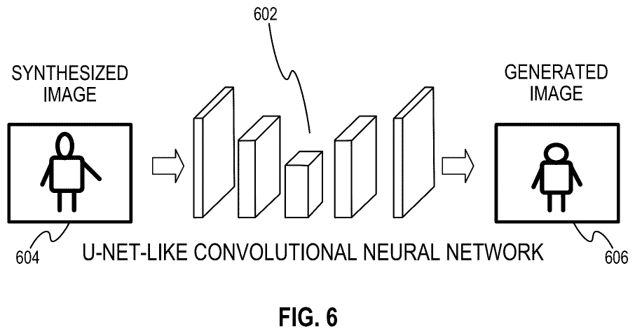

FIG. 6 depicts an overview of an image generation process according to various embodiments of the present disclosure. A U-Net-like convolutional neural network 602 may be used for the image generation network. U-Net is commonly used to enhance images based on input images and target objective functions. To begin, U-Net reduces the resolution of feature maps like typical convolutional neural networks. The low-resolution feature maps are then upscaled with transposed convolution operations, resulting in images 606 that are the same size as the input images 604. These operations convert input image 604 such that they meet the requirements of objective functions, while preserving image contents.

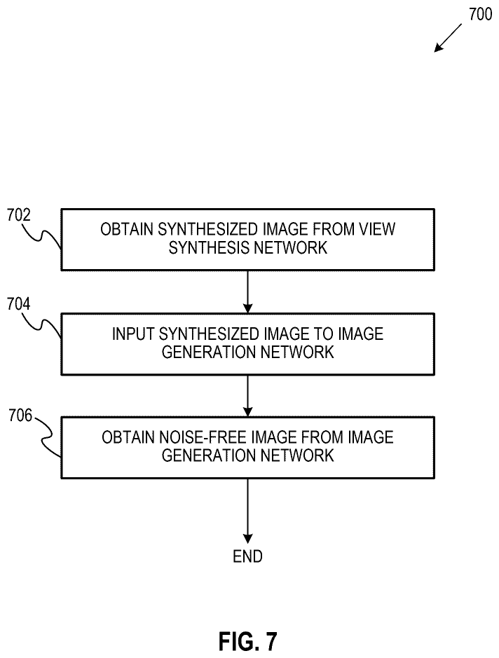

FIG. 7 is a flowchart illustrating an exemplary image generation process according to the overview shown in FIG. 6. Process 700 begins at step 702, when a synthesized image is obtained from a view synthesis network. At step 704, the synthesized image is input to an image generation network. Finally, at step 706, a noise-free image is obtained from the image generation network.

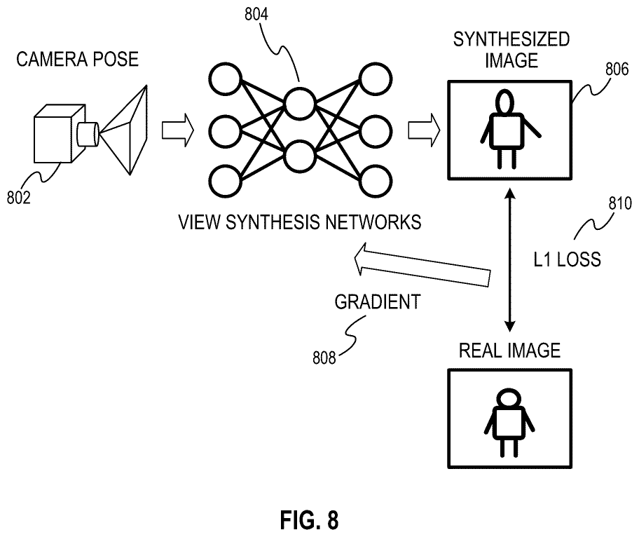

FIG. 8 depicts an overview of an optimization process of a view synthesis network according to various embodiments of the present disclosure. In embodiments, to optimize view synthesis network 804, camera poses 802 are sampled from a first training set. Views are then synthesized based on the input camera poses, and objective functions such as the L1 loss are computed between synthesized image 806 and the real images corresponding to the input camera poses 802. Gradients 808 are calculated based on the objective function 810 and backpropagated to view synthesis network 804. The network parameters are updated with the calculated gradients. This optimization process is repeated, e.g., until objective function 810 values converge.

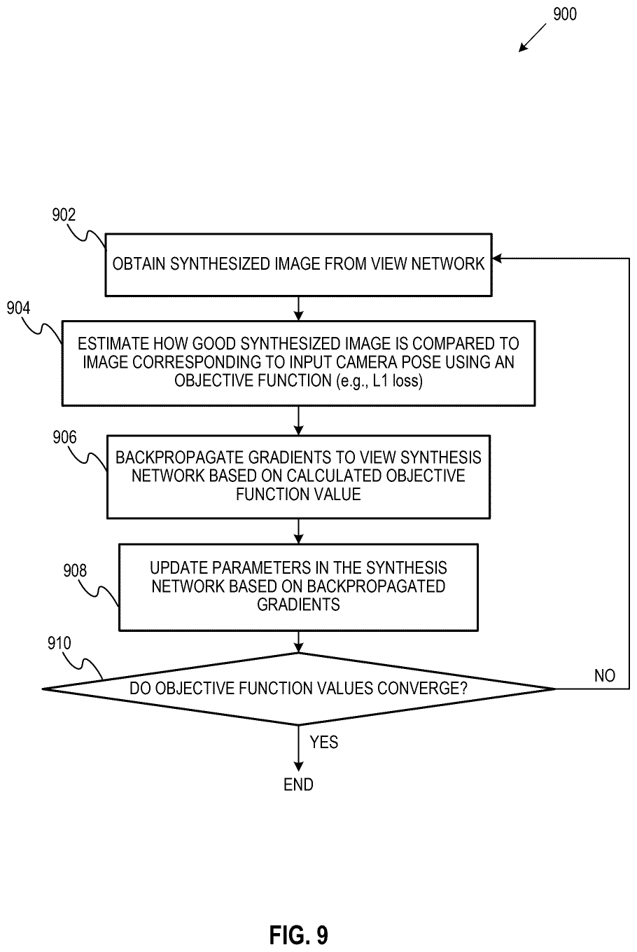

FIG. 9 is a flowchart illustrating an exemplary process according to the overview shown in FIG. 8. Process 900 begins at step 902, when a synthesized image is obtained from a view synthesis network. At step 904, an objective loss function, e.g., L1 loss, is used to evaluate the synthesized image, e.g., by comparing it to an image corresponding to the input camera pose. At step 906, gradients are back propagated to the new synthesis network based on a calculated objective function value. At step 908, based on the back propagated gradients, parameters in the view synthesis network are updated. At step 910, it is determined whether objective function values converge. If so, process 900 stops; otherwise, the process resumes with step 902 to continue with obtaining synthesized images from the view synthesis network.

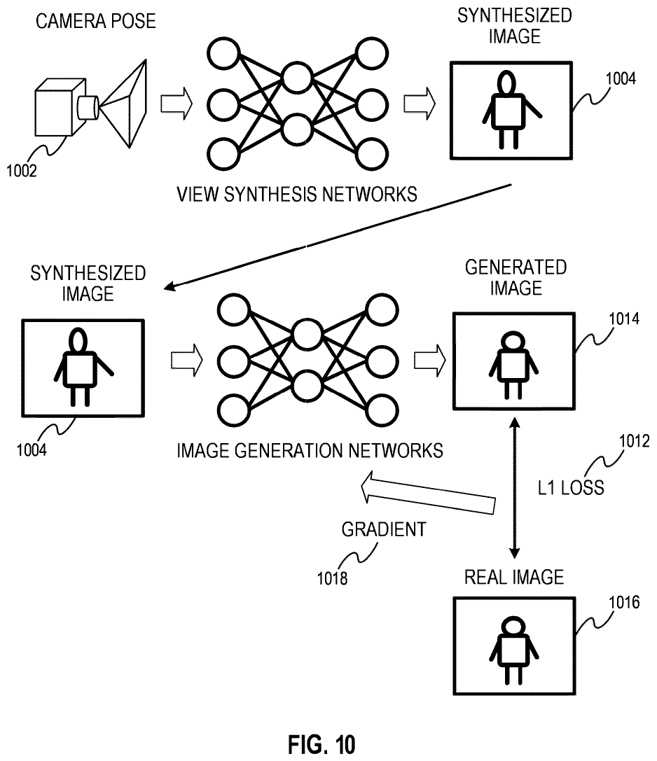

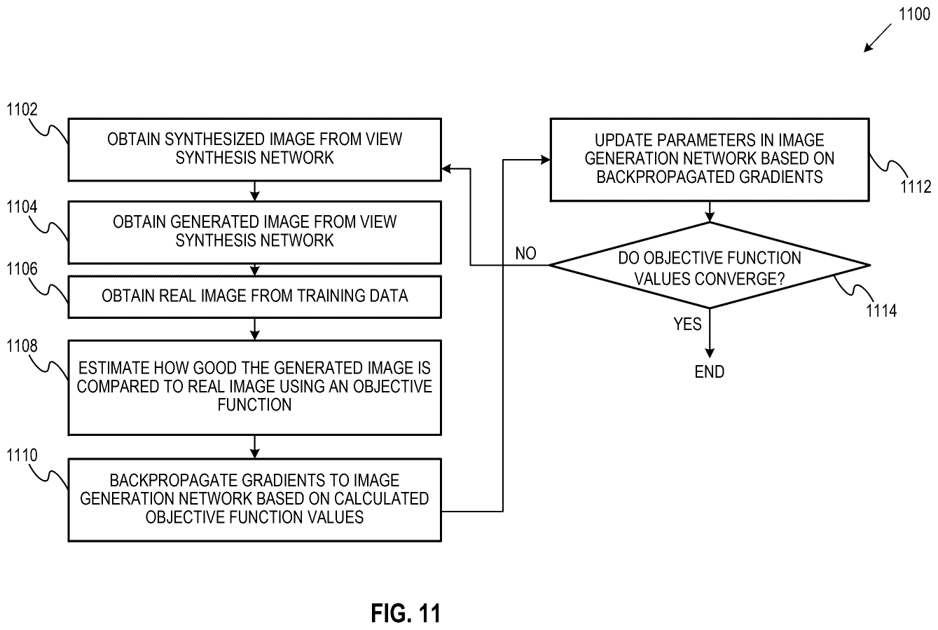

FIG. 10 depicts an overview of an optimization process for image generation network according to various embodiments of the present disclosure. In embodiments, to optimize image generation network 1010, camera poses 1002 are sampled from a second training set. Then, views are synthesized based on input camera poses 1002, synthesized images 1004 are fed into image generation network 1010. Objective functions 1012, e.g., L1 loss are computed between generated images 1014 and real images 1016 that corresponds to input camera pose 1002. Gradients 1018 are calculated based on objective functions 1012 and backpropagated to image generation network 1010. The network parameters are updated with the calculated gradients, and optimization process 1000 is repeated until objective function values converge. FIG. 11 is a flowchart illustrating an exemplary image generation optimization process according to the overview shown in FIG. 10. Process 1100 may begin, at step 1102, when a synthesized image is obtained from a view synthesis network. In response to obtaining an image generated, at step 1104, by an image generation network, A real image may be obtained from training data, at step 1106. At step 1108, the generated image is compared to the real image using an objective function. Based on calculated objective function values, gradients are backpropagated, at step 1110, to the image generation network. At step 1112, the parameters in the image generation network are updated based on the back propagated gradients. At step 1114, it is determined whether the objective function converges. If so, process 1100 stops. Otherwise, process 1100 resumes with step 1102, continuing to obtain synthesized images from the view synthesis network.

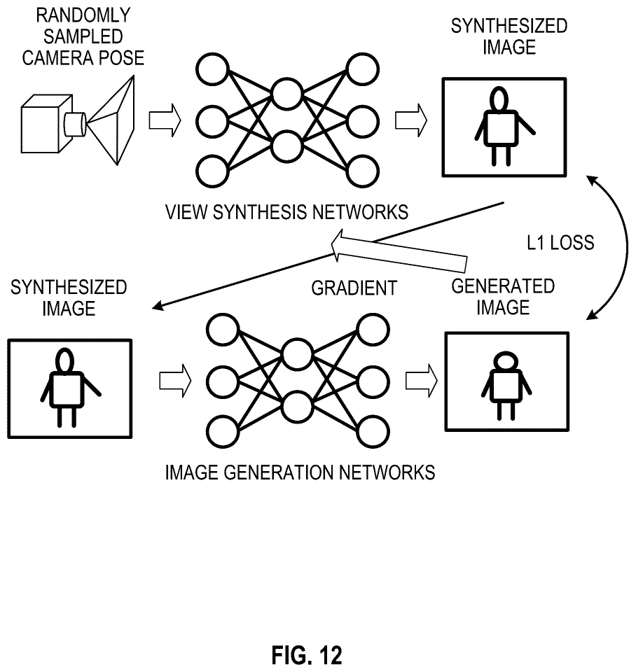

FIG. 12 depicts an overview of an optimization process of a view synthesis network with randomly sampled camera poses according to various embodiments of the present disclosure. In embodiments, to optimize a view synthesis network with randomly sampled camera poses, camera poses are sampled randomly. Views are synthesized based on the input camera poses, and the synthesized images are fed into an image generation network. Objective functions, such as L1 loss, are computed between the synthesized images and the generated images. Gradients are calculated based on the objective functions and backpropagated to the view synthesis network. The network parameters are updated with the calculated gradients. The optimization process is repeated until the objective function values converge.

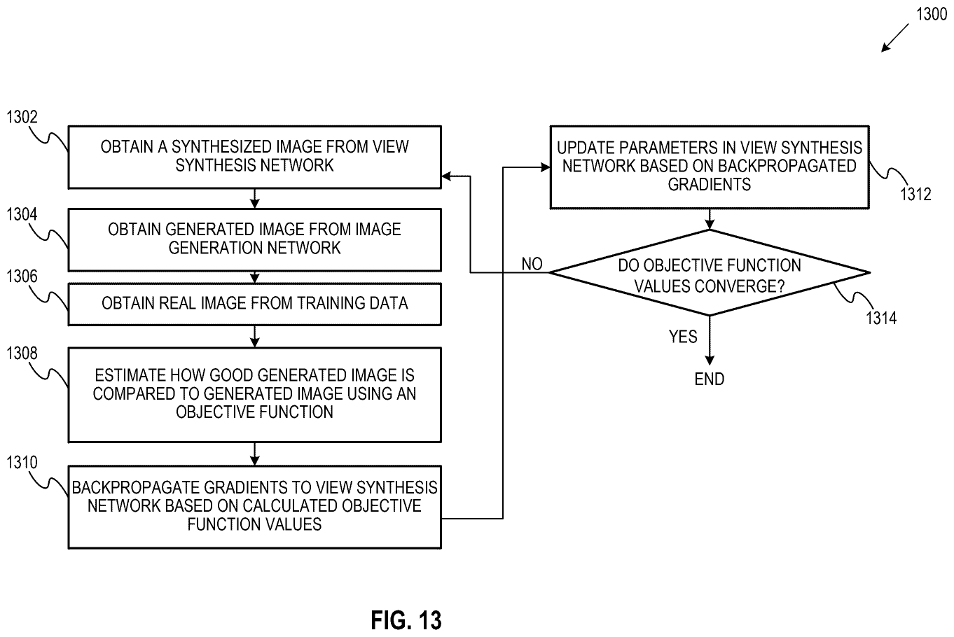

FIG. 13 is a flowchart illustrating an exemplary process according to the overview shown in FIG. 12. Process 1300 may begin at step 1302, when a synthesized image is obtained from a view synthesis network. At step 1304, an image generated by an image generation network is obtained. At step 1306, the generated image is compared to the generated image using an objective function. Based on calculated objective function values, gradients are backpropagated, at step 1308, to the view synthesis network. At step 1310, the parameters in the view synthesis network are updated based on the backpropagated gradients. At step 1112, it is determined whether the objective function converges. If so, process 1300 stops. Otherwise, process 1300 resumes with step 1302, continuing to obtain synthesized images from the view synthesis network.

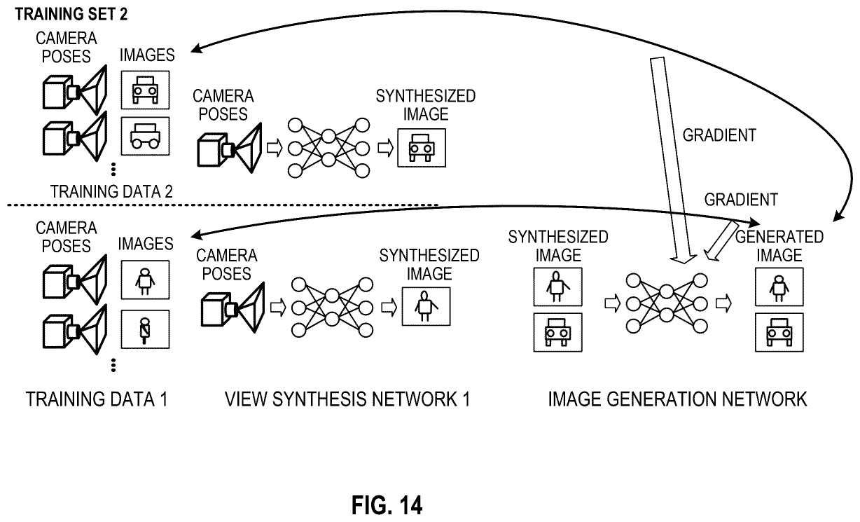

FIG. 14 depicts an overview of a process for sharing an image generation network according to various embodiments of the present disclosure. In this process, one or more view synthesis networks are optimized separately for different target objects or sites. However, the gradients calculated for noise reduction are accumulated in the image generation network from all view synthesis networks. This gradient accumulation allows the knowledge to reduce artifact noises to be shared, thus improving noise reduction performance.

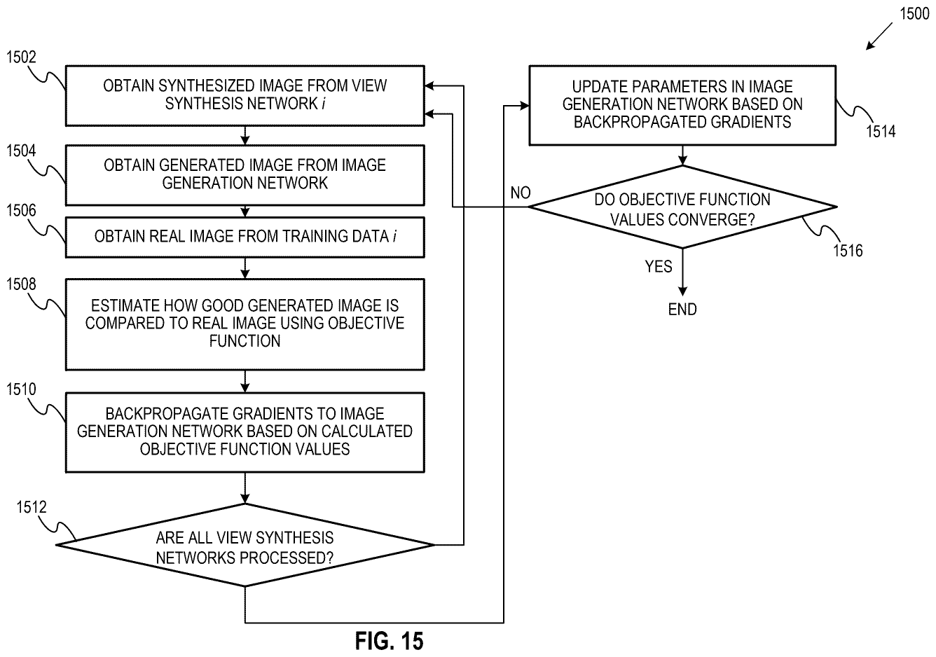

FIG. 15 is a flowchart illustrating an exemplary process according to the overview shown in FIG. 14. Process 1500 may begin at step 1502, when a synthesized image is obtained from a synthesis network i. In response to obtaining, at step 1504, an image generated from an image generation network, a real image may be obtained from training data i, at step 1506. At step 1508, the generated image is compared to the real image using an objective function. Based on calculated objective function values, gradients are backpropagated, at step 1510, to the image generation network. At step 1512, it is determined whether all view synthesis networks have been processed. If so, process 1500 updates, at step 1514, the parameters in the image generation network based on the back propagated gradients. At step 1516, it is determined whether the objective function converges. If so, process 1500 stops. Otherwise, process 1500 resumes with step 1502, to continue obtaining synthesized images from the view synthesis network i.

One skilled in the art shall recognize that: (1) certain steps may optionally be performed; (2) steps may not be limited to the specific order set forth herein; (3) certain steps may be performed in different orders; and (4) certain steps may be done concurrently.

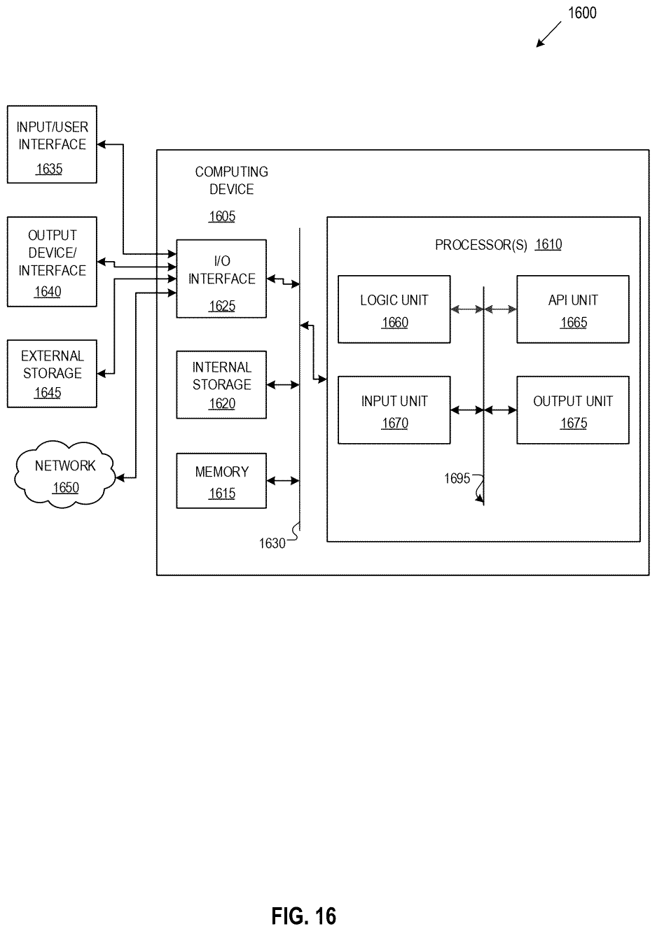

FIG. 16 illustrates an example computing environment with an example computer device suitable for use in some example implementations. Computer device 1605 in computing environment 1600 can include one or more processing units, cores, or processors 1610, memory 1615 (e.g., RAM, ROM, and/or the like), internal storage 1620 (e.g., magnetic, optical, solid-state storage, and/or organic), and/or I/O interface 1625, any of which can be coupled on a communication mechanism or bus 1630 for communicating information or embedded in the computer device 1605. I/O interface 1625 is also configured to receive images from cameras or provide images to projectors or displays, depending on the desired implementation.

Computer device 1605 can be communicatively coupled to input/user interface 1635 and output device/interface 1640. Either one or both of input/user interface 1635 and output device/interface 1640 can be a wired or wireless interface and can be detachable. Input/user interface 1635 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1640 may include a display, television, monitor, printer, speaker, braille, or the like. In some example implementations, input/user interface 1635 and output device/interface 1640 can be embedded with or physically coupled to the computer device 1605. In other example implementations, other computer devices may function as or provide the functions of input/user interface 1635 and output device/interface 1640 for a computer device 1605.

Examples of computer device 1605 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1605 can be communicatively coupled (e.g., via I/O interface 1625) to external storage 1645 and network 1650 for communicating with any number of networked components, devices, and systems, including one or more computer devices of the same or different configurations. Computer device 1605 or any connected computer device can be functioning as, providing services of, or referred to as a server, client, thin server, general machine, special-purpose machine, or another label.

I/O interface 1625 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1600. Network 1650 can be any network or combination of networks (e.g., the Internet, local area network, wide area network, a telephonic network, a cellular network, a satellite network, and the like).

Computer device 1605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1610 can execute under any operating system (OS) (not shown), in a native or virtual environment. One or more applications can be deployed that include logic unit 1660, application programming interface (API) unit 1665, input unit 1670, output unit 1675, and inter-unit communication mechanism 1695 for the different units to communicate with each other, with the OS, and with other applications (not shown). The described units and elements can be varied in design, function, configuration, or implementation and are not limited to the descriptions provided. Processor(s) 1610 can be in the form of hardware processors such as central processing units (CPUs) or a combination of hardware and software units.

In some example implementations, when information or an execution instruction is received by API unit 1665, it may be communicated to one or more other units (e.g., logic unit 1660, input unit 1670, output unit 1675). In some instances, logic unit 1660 may be configured to control the information flow among the units and direct the services provided by API unit 1665, input unit 1670, and output unit 1675, in some example implementations described above. For example, the flow of one or more processes or implementations may be controlled by logic unit 1660 alone or in conjunction with API unit 1665. The input unit 1670 may be configured to obtain input for the calculations described in the example implementations, and the output unit 1675 may be configured to provide output based on the calculations described in example implementations. Processor(s) 1610 can be configured to execute a method or computer instructions which can involve capturing images of one or more target objects or sites using cameras; estimating camera poses for the captured images; for each target object or site, and dividing training samples including image-camera pose pairs into a first training set and a second training set, and provide camera poses associated with the first training set to a view synthesis network, which synthesizes views from the camera poses to obtain a first set of synthesized images, as described, for example, with respect to FIG. 2 and FIG. 10. Processor(s) 1610 can be configured to execute a method or computer instructions which can involve comparing the first set of synthesized images with images in the first training set to obtain a first comparison result; inputting the first comparison result to the view synthesis network; providing camera poses associated with the second training set to the view synthesis network, which synthesizes views from the camera poses to obtain a second set of synthesized images; and providing the second set of synthesized images to an image generation network to generate noise-reduced images, as described, for example, with respect to FIG. 2 and FIG. 7. Processor(s) 1610 can further be configured to execute a method or computer instructions which can involve comparing the noise-reduced images with images in the second training set to obtain a second comparison result, and inputting the second comparison result to the image generation network, wherein the view synthesis network has not been trained on images associated with the second training set, as described, for example, with respect to FIG. 2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for reducing noise in synthesized images generated by a view synthesis network using an image generation network, the method comprising:
capturing images of one or more target objects or sites using cameras;
estimating camera poses for the captured images;
for each target object or site, dividing training samples comprising image-camera pose pairs into a first training set and a second training set;
providing camera poses associated with the first training set to a view synthesis network, which synthesizes views from the camera poses to obtain a first set of synthesized images;
comparing the first set of synthesized images with images in the first training set to obtain a first comparison result;
inputting the first comparison result to the view synthesis network;
providing camera poses associated with the second training set to the view synthesis network, which synthesizes views from the camera poses to obtain a second set of synthesized images;
providing the second set of synthesized images to an image generation network to generate noise-reduced images;
comparing the noise-reduced images with images in the second training set to obtain a second comparison result; and
inputting the second comparison result to the image generation network, wherein the view synthesis network has not been trained on images associated with the second training set.

2. The method of claim 1, further comprising using the noise-reduced images as additional training samples for the view synthesis network.

3. The method of claim 1, wherein the synthesized views from randomly sampled camera poses are input into the image generation network before being used as additional training samples.

4. The method of claim 3, further comprising using at least some of the randomly sampled camera poses to train view synthesis networks to enable the view synthesis networks to learn additional 3D structures consistently.

5. The method of claim 1, wherein estimating the camera poses for the captured images comprises using at least one of a structure-from-motion algorithm or a point-matching algorithm, wherein the point-matching algorithm is used in response to capturing depth data with 3D sensors to enhance a camera pose estimation.

6. The method of claim 4, further comprising sharing one or more image generation network parameters across two or more of the view synthesis networks to improve a noise reduction performance based on accumulated training data.

7. The method of claim 6, wherein the accumulated training data uses training data from two or more target objects or sites.

8. The method of claim 6, wherein the image generation network learns from training data of different target objects or sites.

9. The method of claim 6, wherein the one or more shared image generation networks use training data from multiple target objects or sites to enhance noise reduction performance across different view synthesis networks.

10. The method of claim 9, wherein each of the different view synthesis networks learns its own target site or object.

11. The method of claim 10, wherein the view synthesis networks generate views by casting rays from a camera center in a view direction and sampling points along the rays.

12. The method of claim 1, further comprising optimizing the image generation network by comparing synthesized images with real images from the second training set using an objective function.

13. The method of claim 1, further comprising calculating pixel values of the view by integrating colors and densities of sampled points.

14. A non-transitory computer-readable medium for storing instructions for executing a process, the instructions comprising:
in response to cameras capturing images of one or more target objects or sites, estimating camera poses for the captured images;
for each target object or site, dividing training samples comprising image-camera pose pairs into a first training set and a second training set;
providing camera poses associated with the first training set to a view synthesis network, which synthesizes views from the camera poses to obtain a first set of synthesized images;
comparing the first set of synthesized images with images in the first training set to obtain a first comparison result;
inputting the first comparison result to the view synthesis network;
providing camera poses associated with the second training set to the view synthesis network, which synthesizes views from the camera poses to obtain a second set of synthesized images;
providing the second set of synthesized images to an image generation network to generate noise-reduced images;
comparing the noise-reduced images with images in the second training set to obtain a second comparison result; and
inputting the second comparison result to the image generation network, wherein the view synthesis network has not been trained on images associated with the second training set.

15. The non-transitory computer-readable medium of claim 14, the instructions further comprising using the noise-reduced images as additional training samples for the view synthesis network.

16. The non-transitory computer-readable medium of claim 14, wherein the synthesized views from randomly sampled camera poses are input into the image generation network before being used as additional training samples.

17. The non-transitory computer-readable medium of claim 16, the instructions further comprising using at least some of the randomly sampled camera poses to train view synthesis networks to enable the view synthesis networks to learn additional 3D structures consistently.

18. The non-transitory computer-readable medium of claim 17, the instructions further comprising sharing one or more image generation network parameters across two or more of the view synthesis networks to improve a noise reduction performance based on accumulated training data.

19. The non-transitory computer-readable medium of claim 18, wherein the one or more shared image generation networks use training data from multiple target objects or sites to enhance noise reduction performance across different view synthesis networks.

20. The non-transitory computer-readable medium of claim 19, wherein each of the different view synthesis networks learns its own target site or object.
